(19) United States
(12) Patent Application Publication
(10) Pub. No.: US 2016/0005027 A1
(43) Pub. Date: Jan. 7, 2016

(54) METHOD AND APPARATUS FOR AUTOMATED ORDERING AND PAYMENT

(71) Applicant: James B. Kargman, Chicago, IL (US)

(72) Inventor: James B. Kargman, Chicago, IL (US)

(21) Appl. No.: 14/857,236

(22) Filed: Sep. 17, 2015

Related U.S. Application Data
(63) Continuation of application No. 12/409,227, filed on Mar. 23, 2009.

(51) Int. Cl. G06Q 20/32; G06F 17/30; G06Q 30/06

(52) U.S. Cl. CPC G06Q 20/3276; G06Q 30/0633; G06F 17/30879; G06F 17/30887

(57) ABSTRACT

A method and apparatus for ordering and payment using a mobile device such as a mobile telephone. A graphical code element corresponding to goods to be ordered is scanned or photographed using a camera function on the mobile phone, the code is decoded by the phone, and an order for the goods is transmitted by the phone. The order transmission may include user address information for the delivery of the goods and payment information. Payment for goods or services includes scanning or photographing a code with price and payee information using the mobile device. The code is decoded and payment information is sent by the mobile device. The code for the payment may be presented to the purchaser by a seller as a displayed code on a mobile device of the seller, such as on a mobile device of a delivery person delivering the goods. The purchaser images the displayed code using the purchaser's mobile device to initiate the payment.

### CROSS-REFERENCE TO RELATED APPLICATIONS

This application claims the benefit of U.S. Provisional Patent Application Ser. No. 61/038,924, filed Mar. 24, 2008, which is incorporated herein by reference.

This application is a continuation application of co-pending U.S. patent application Ser. No. 12/409,227, filed Mar. 23, 2009, which is incorporated herein by reference.

### BACKGROUND OF THE INVENTION

1. Field of the Invention

The present invention relates generally to a method and apparatus for automated ordering and in particular to a method and apparatus for automated ordering using a mobile telephone or the like to read a code and transmit information. A method and apparatus for automated payment using a mobile phone is also provided.

2. Description of the Related Art

Food preparation and delivery shops, such as pizza delivery shops, need fast and accurate order information from customers placing orders. Customers need a secure system to make payments for such orders.

U.S. Pat. No. 7,197,478 B2 is related to placing orders using a URL address.

U.S. Pat. No. 5,991,739 is related to matching an address of a user placing an order to an address of a nearest order fulfillment facility.

Co-pending U.S. application Ser. No. 11/875,733 is related to compressing large URL addresses.

### SUMMARY OF THE INVENTION

The present invention provides a method and apparatus for automated order placement for electronic commerce. In one example, a user photographs a graphical code element associated with an item the user wishes to order using a camera phone. The camera phone decodes the graphical element and places an order for the desired item electronically. The order is placed accurately and quickly.

The present method and apparatus also provides for authentication for payment of electronic transactions using a mobile telephone. The mobile telephone is used to verify the identity of the user for the payment. User identification may be verified using a variety of identification means.

### BRIEF DESCRIPTION OF THE DRAWINGS

FIG. 1 is an example of a two dimensional graphical code element of a type that may be used in the present invention;

FIG. 2 is a process flow chart showing the steps in performing the present method;

FIG. 3 is a functional block diagram of a transaction according to the principles of the present invention; and

FIG. 4 is a functional block diagram of a mobile telephone as used in one example of the present method.

### DETAILED DESCRIPTION OF THE PREFERRED EMBODIMENTS

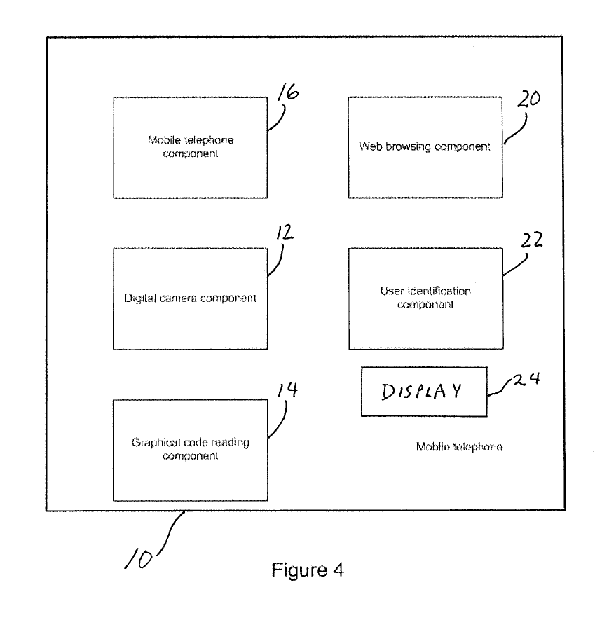

The present method and apparatus brings together a mobile telephone 10 in FIG. 4 with a code reading functionality, an order transmitting functionality, and a payment functionality. The code reading functionality is provided by a digital camera 12 incorporated into the mobile telephone 10, which is becoming an increasingly popular combination and is also referred to as a camera phone, and that further includes code reading software 14, so that images of a visual code element such as a two dimensional grid code obtained by the camera portion 12 of the mobile telephone 10 are read by the software. The telephone portion 16 transmits the code that has been obtained by the software. The transmitted code is a step in an electronic transaction. The code transmittal may be an order or a payment or a combination of both an order and a payment. The use of the mobile telephone to read the code triggers a transaction or provides a further step in a transaction that is already underway.

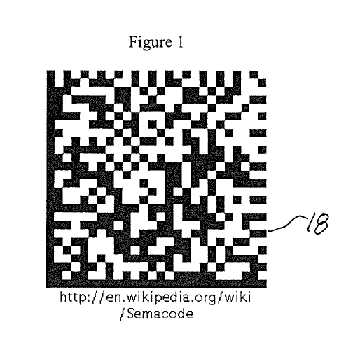

The two dimensional grid code 18 in FIG. 1 read by the mobile telephone 10 can include a URL (uniform resource locator), also known as a web address, at which the item of interest may be ordered. The mobile phone 10 may include a web browsing component 20 to access the web site at the web address. The URL may also include payment information by which an electronic payment is made for the ordered item and user information so that the ordered item can be delivered to the user and payment is authenticated. The URL embedded in the code element may be the full URL or may be a compressed or shortened URL that is expanded or that redirects to the full URL.

The mobile telephone 10 may also have an identification functionality 22 so as to authenticate the identity of the user. The mobile telephone provides a positive confirmation of the user's identity through the use of a PIN code, by a fingerprint reader, a facial recognition function, or other user identification means. The authentication may also be by object recognition instead of or in addition to face recognition. The telephone 10 serves for user identity verification, adding a layer of security to the electronic payment. The telephone 10 authenticates the user identity and transmits the payment request, so that the telephone is the payment mechanism. The mobile telephone payment may be tied to a credit card account so that payment is made by a charge to a credit card account or the payment may be made by a wire transfer, or by some other electronic payment or transaction.

A further development provides that the user may interact with a seller using the code reading 14 and displaying 24 capabilities of the mobile telephone 10. A person seeking payment for goods or services causes their mobile telephone display 24 to show a graphical code element such as 18 in FIG. 1 that encodes some information about the transaction, such as price, payee, etc. The user who wishes to pay for the goods or services photographs or scans the displayed graphical code using the camera component 12 of their own mobile telephone, which reads the code and sends payment information to cause a payment to be made to the seller. This transaction can take place at the door of the user's home during a delivery of goods, for example, or anywhere when payment for services is requested.

An exchange of information between mobile telephones is done by visual display of a code such as code 18 displayed on the display 21 and by reading of the visually displayed code using the camera component 12. This visual component of the transaction is typically done in the presence of people. It also limits the exchange to those devices that are visible to the people carrying out the transaction and prevents, for example, surreptitious reading of exchanged data, as can happen with radio communications. This adds a level of security that may not be present for non-visual communications between electronic devices using, for example, Bluetooth technology or other radio frequency transmissions absent the use of complex authentication means.

This visual exchange is further authenticated by the verification of the user's identity by the delivery person. One element of authentication is by delivery to a particular address and the delivery person receiving payment for the goods from a person at that address. Additional forms of verification could include taking a picture of the face of the customer and matching the picture using biometric analysis software, or by using a built in biometric device such as a fingerprint or other biometric reader incorporated into the device. This can be carried out using a mobile telephone or other mobile device of the delivery person. Other verification methods may include visual, voice or keystroke entry of a personal code. The verification code may be entered visually by directing the camera to a code, such as a grid code, for example, a semacode or other code format. The verification may be carried out by a plug in memory chip, one example of which is a memory chip that is plugged into the mobile phone and another example of which is input via a USB (universal serial bus) or other connector. Another identify verification may be carried out by one or more pre-stored codes that are accessed via a keyboard request, for example. Yet another verification may be provided by speaker dependent voice recognition by prompting with a passphrase that is compared to a prerecorded passphrase recording.

The display of a two dimensional graphical code element 18 on the mobile telephone 10 can be presented in a store, for example, for scanning by the store's scanning or code reading apparatus. User information or product information is thereby conveyed to the store. Where the code has been transmitted to the user for example as an electronic coupon including the graphical code element, the user may display the code element 18 on the display 24 of the mobile phone 10 to the store scanner to redeem the coupon. Thus, the mobile telephone display 24 triggers a coupon redemption.

The store, restaurant or other seller may provide a graphical code element 18 to the user representing the price of the items provided to the user and the user photographs or scans the graphical code element 18 using the camera component 12 to provide a payment to the seller. For example, a customer in a restaurant may receive a bill for the meal with a code element 18 and the customer pays the bill using the camera and code reading functionality 12 and 14 on the customer's mobile phone 10 to pay the bill.

Mobile telephones 10 having built-in cameras 12 and the ability to transmit the images obtained by the camera function have become readily available. Such mobile telephones typically have display screens 24 which display images obtained by the camera as well as to display images transmitted to the telephone. Mobile telephones are also available that include Internet access functionalities including the ability to access Internet sites on the World Wide Web using a URL (Uniform Resource Locator) through a web browser function 20. Such mobile telephones transmit the URL request and receive and display the information at that location. As such, the present method uses available technology to perform the method steps. It is also foreseen that the mobile telephone may be provided with a code scanner in place of or in addition to the camera functionality.

References to a mobile telephone for purposes of the present invention encompass many different devices and all such devices are within the scope of this invention. For example, a handheld wireless email device, personal organizer, personal music player, personal game device, or other such devices all fall under the definition of mobile telephone as used here. Further, the invention is not limited to mobile device but may include wired devices, such as wired telephones, scanners, bar code and two-dimensional code readers, cash registers and other point-of-sale devices.

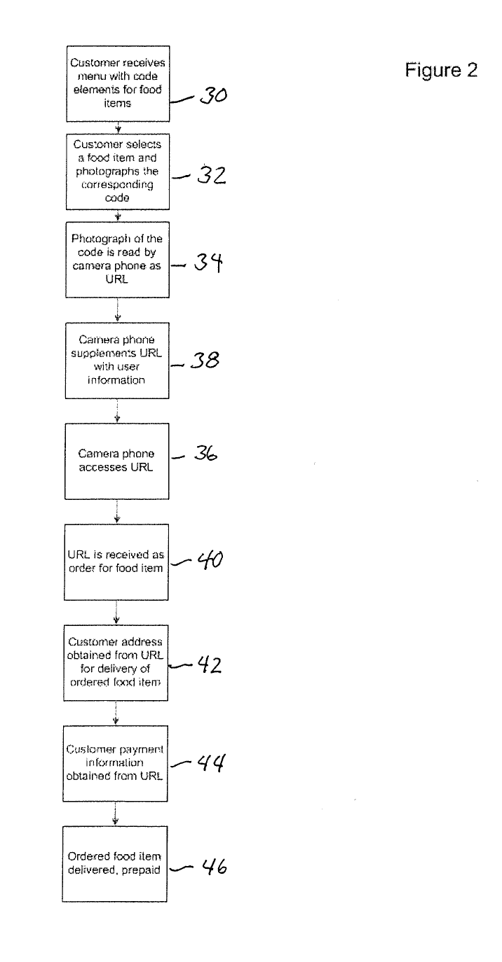

An example of a method according to one embodiment is illustrated in FIG. 2. A customer of a food delivery service receives a menu with code elements at step 30. The customer selects a menu item and photographs the associated code at step 32. The code is read by the camera phone as a URL at step 34. The Internet component of the camera phone accesses the URL at step 36, which transmits an order for the food item to the food preparer. The customer address is included in the order, such as by being embedded in the URL or being derived therefrom at step 38. The payment for the food item is also included in the URL or is derived therefrom also at step 38. The transmittal URL information is received by the seller as an order at step 40. The customer address information is obtained from the URL at step 42. The payment information for the order may also be derived from the URL at step 44. The food item is delivered to the customer prepaid at step 46. Alternatively, the payment may be made by transmitting a confirmation of delivery of the food item by the customer, such as by transmitting a confirmation code by the customer.

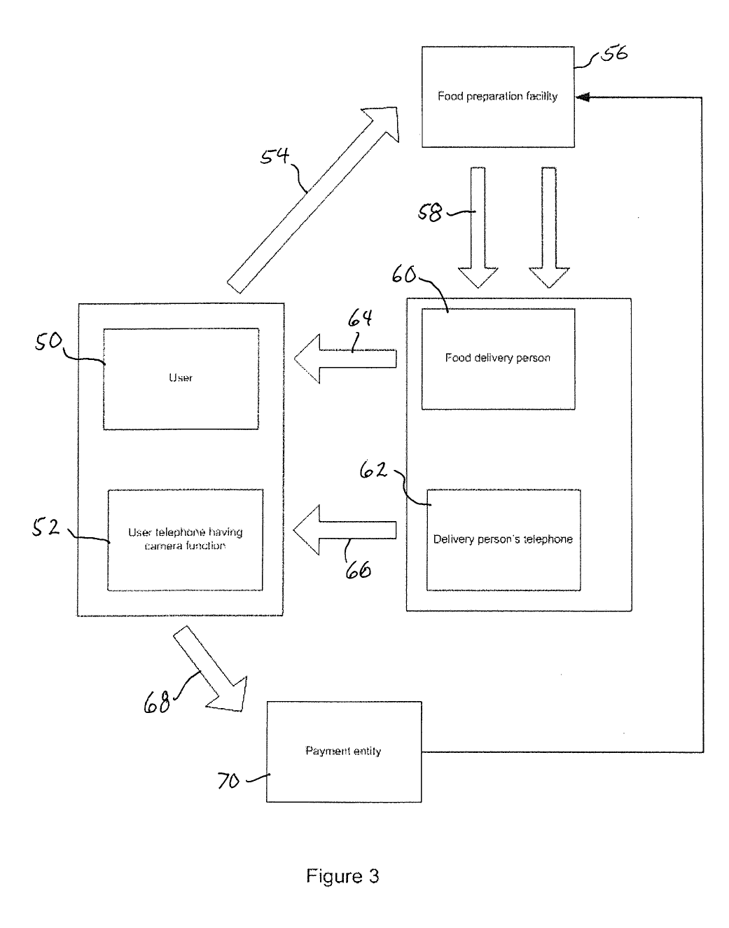

FIG. 3 illustrates the components of the delivery method and apparatus. A user 50 has a mobile telephone with a camera function 52. An order 54 is transmitted to a food preparation facility 56 by imaging a graphical code element associated with a desired food item so that the phone transmits the order for that item. The food preparation facility prepares the ordered food item or items 58 and provides them to a delivery person 60. The delivery person 60 has a mobile telephone 62 as well with an ability to display a graphical code for payment for the delivered items. The delivery person delivers at 64 the food items to the customer 50 and presents at 66 a visual display of the graphical code for payment to the customer. The customer 50 images the payment code on the delivery person's phone 62 using the customer's mobile phone 52 and instructs the customer's phone 52 to send at 68 the payment 68. The payment code 68 is transmitted to a payment entity 70, such as bank or other financial institution, which transmits the payment 72 to the food preparation facility 56.

FIG. 4 shows a mobile telephone 10 that may be used in the present method. The mobile telephone has a mobile telephone component 16 providing communications capability. A digital camera component 12 provides imaging and image display capabilities in conjunction with the display 24. A graphical code reading component 14, which may be entirely of software or of firmware, provides the functionality to read the graphical codes of the camera images. The web browsing component 20 provides the functionality to access URL addresses that may be obtained by reading the codes. A user identification 22 is an optional functionality such as a fingerprint reader, iris reader, retina scanner, PIN code reader, dongle connection, or other unique identification to authenticate a part of the transaction. The authentication may also be a face recognition or object recognition functionality.

According to one embodiment of the present invention, a pizza delivery company, for example, provides a publication showing items offered by the company for pick up or delivery. For example, the company distributes an advertisement listing or showing the various items offered for pick up or delivery by the company. The advertisement may be coupons, magazine or newspaper ads, mail ads or other advertising for the company. Instead of advertising, the publication may be a menu showing items available from the company. The publication includes a graphical code element 18 associated with one or more items that are offered by the company. For example, the publication may be a carry-out restaurant menu with a listing of the food items available for carry out or delivery and having a graphical code element associated with each food item.

A user desiring a food item, uses a camera phone 10 or other similar device to photograph the graphical code 18 for the desired food item. The user may use some other device, such as a scanner for example, to capture the information from the graphical code element. One example of a graphical code element is a semacode, which is a two dimensional, grid-like graphical element having information encoded therein. A sample of a two-dimensional grid code is shown in FIG. 1. Any other type of two dimensional code element may also be used. Bar codes or other one dimensional code elements may also be used, or other types of codes that are capable of being read optically may be used. Software to read the graphical codes is available and here is incorporated into the mobile telephone. Information on two dimensional codes may be found at the following Internet addresses:

http://semacode.com/,

http://en.wikipedia.org/wiki/Semacode, or

http://www.mobiletags.biz/app/topic/index_{—}004.cfm?fuseaction=OpenTopic&coid=13&lang=en&CFID=3114563&CFTOKEN=ad9de683bd832081-B9672F07-96BB-5A17-A01FBACD5AEDEA68

The user's camera phone 10 is provided with software or other tools 14 so that it is capable of reading the code that has been photographed or otherwise scanned by the camera phone. The decoded information of one embodiment is a URL address for an Internet site. In a preferred development, the URL is an order accepting site for the company through which orders may be placed for the item selected by the customer. For example, the publication shows a particular style of pizza in a particular size with particular toppings. By photographing the graphical code element associated with that pizza, the camera phone reads the code element and obtains the URL address of the company offering that pizza.

The quantity of information encoded in such two dimensional code elements is limited, so lengthy URL addresses may be shorted by providing a small URL or compressed URL in the code, that in turn redirects the user to a longer URL or is decoded to obtain the longer URL. On example of a system for providing this function is shown in co-pending U.S. patent application Ser. No. 11/875,73.

The user's camera phone 10 may also provide user specific information at 38 in FIG. 2 as an add-on part of the URL so that the URL also includes user address information, user credit card information and other user specific information. Features such as those shown in U.S. Pat. No. 7,197,478 may be used. The URL with the order information and the user information is transmitted via the user's camera phone, which results in an order being placed automatically for the desired food item, paid for using the user's credit card information, and set for delivery to the user's home or place of business as specified in the add-on information. Of course, the payment may be by a check card, wire transfer or other payment means instead of a credit card.

In order to make the delivery to the user's home or business, the order must be placed with a shop near the user, and preferably the nearest shop to the user. A system for matching the user address to the nearest food delivery shop is thereby provided. One such system is shown in U.S. Pat. No. 5,991,739.

It is also foreseen that the code element 18 may be transmitted to the user's phone so that the user need not photograph the code element but instead would select the code element that has been sent to the phone as a message, for example. A coupon, menu or other promotional information may be sent to the user's phone 10. The user may select a food item from the information and preferably select a graphical code in the information. The graphical code element is read as before, the code transmitted and the item is thereby ordered.

In addition to the automation of the sales transaction, provisions can be included in the design of the user interface to allow the entry of a Personal Identification Number or “PIN” code, known only to the owner of the cell phone. This same functionality can also be provided by the insertion of a “token” or electronic key that might include a synchronized time value, to provide a secondary mechanism for authentication. An example of such a token is provided under the tradename RSA SecurID. Alternative authentication or identification means may be provided; for example, a magnetic strip card reading capability may be provided on the mobile telephone or as an add-on thereto, or a dongle, memory element or other code containing element may be connected to the mobile telephone. Each of these may be within the functional block 22 in FIG. 4.

The computational capability of the computing element in the cell phone can also be utilized to perform additional functions such as ticket splitting, currency conversions, and other transaction related activities.

Payments 68 in FIG. 3 originating from such a interactive transaction processor could be tied to a third party payment system such as a credit card, or they can be tied directly to a bank account, or to a payment system hosted by the cell phone company that provides the communication channel for the telephone, or other payment systems such as the Paypal payment service.

It is foreseen that this invention can be used for ordering and paying for items other than food items. Products or services may be ordered or paid for using the present method and apparatus. All such other items are encompassed by the present invention.

Although other modifications and changes may be suggested by those skilled in the art, it is the intention of the inventors to embody within the patent warranted hereon all changes and modifications as reasonably and properly come within the scope of their contribution to the art.

I claim:

1. A method of ordering goods or services, comprising the steps of:
generating a code corresponding to the goods or services, the code including an optical code with encoding identifying information of at least one of the goods or services and information of a payee of the at least one of the goods or services;
imaging the code with an imaging component of a mobile device, the code imaged by the mobile device corresponding to a selected one of the goods or services selected by a buyer;
decoding the code with the mobile device to obtain the identifying information of the selected one of the goods or services and the information of the payee of the selected one of the goods or services;
receiving transmitted data that is transmitted from the mobile device of a user, the transmitted data including the decoded information of the optical code relating to the selected one of the goods and services obtained by imaging of the optical code by the mobile device; and
providing the selected one of the goods or services to the user.

2. A method as claimed in claim 1, wherein said optical code includes URL (uniform resource locator) information encoded in the optical code, wherein said step of decoding the code includes decoding the URL in the mobile device, and wherein said step of receiving the transmitted data receives the transmitted data at an Internet address corresponding to the URL.

3. A method as claimed in claim 1, wherein said step of providing the goods or services includes delivering the selected one of the goods or services to the user.

4. A method as claimed in claim 3, wherein said step of receiving the transmitted data includes receiving address information for the delivery of the selected one of the goods or services.

5. A method as claimed in claim 4, wherein said address information is included in a URL (uniform resource indicator) received in said receiving step, the URL including the receiving address for delivery of the goods or services being encoded in the optical code for decoding by the mobile device.

6. A method as claimed in claim 1, wherein said step of receiving the transmitted data includes receiving payment information for the selected one of the goods or services, the payment information being encoded in a URL (uniform resource indicator) received in said receiving step, the URL including the payment information being encoded in the optical code for decoding by the mobile device.

7. A method as claimed in claim 1, wherein said step of generating the code generates an optical code as a printed code.

8. A method as claimed in claim 1, further comprising the step of:
transmitting the optical code to the mobile device of the user as image data for decoding.

9. A method as claimed in claim 1, further comprising the step of:
transmitting the optical code to a mobile device of a delivery person as image data for display on a display screen of the mobile device of the delivery person.

10. A method of receiving payment for goods or services, comprising the steps of:
offering goods or services to a customer;
generating an optical code corresponding to at least one of the goods or services and including code information of a seller of the one of the goods or services;
displaying the optical code to the customer;
imaging the optical code of a selected on of the goods or services as selected by the customer, the imaging step being performed with an imaging component of the mobile device;
decoding the optical code with the mobile device to obtain decoded information of the selected one of the goods or services; and
receiving transmitted data from a mobile device of a user, the transmitted data including decoded information of the optical code and including payment information for the selected one of the goods or services.

11. A method as claimed in claim 10, wherein said step of displaying the optical code includes displaying a printed optical code.

12. A method as claimed in claim 10, wherein said step of displaying the optical code includes displaying the optical code on a display panel.

13. A method as claimed in claim 10, wherein said optical code includes a URL (uniform resource locator).

14. An apparatus for ordering goods or services, comprising:
a mobile electronic device including:
a mobile transceiver component operable for transmitting and receiving data signals;
an optical reader component operable to read optical codes;
a graphical code decoding component operable to decode optical codes read by said optical reader component, said graphical code decoding component decoding codes corresponding to the goods or services;
a user identification component operable to add user information to the codes corresponding to the goods or services; and
said mobile transceiver component being operable to transmit order information, said order information including information corresponding to the goods or services and user information.

15. An apparatus as claimed in claim 14, wherein said mobile electronic device is a mobile telephone.

16. An apparatus as claimed in claim 14, wherein said mobile transceiver component is operable to transmit URL (uniform resource locator) data.

17. An apparatus as claimed in claim 14, wherein said mobile transceiver component is operable to transmit payment data.

18. An apparatus as claimed in claim 14, wherein said graphical code decoding component is operable to decode a graphical code received as image data by said mobile transceiver component.

19. A method for providing goods or services to be ordered, comprising the steps of:
generating order codes for items to be offered for delivery;
preparing a delivery menu of the items to be offered for delivery, the delivery menu including the order codes corresponding to the items to be offered for delivery, the order codes being two-dimensional codes;
distributing copies of the delivery menu to a plurality of prospective customers;
receiving an order from a customer as a received order, the received order including order data resulting from imaging of a portion of the menu containing the order code corresponding to a selected item of the items for delivery and decoding of the order code to obtain the order data, the received order including a customer delivery address;
preparing the select item for delivery;
obtaining the delivery address of the customer from the received order; and
delivering the selected item to the delivery address.

20. The method as claimed in claim 19, further comprising the steps of:
generating a payment code corresponding to the selected item, the payment code including payee information;
upon delivery of the selected item, presenting the payment code to the customer for authorization; and
receiving payment for the selected item.

21. The method as claimed in claim 19, wherein the step of receiving the order includes receiving payment information with the order data.
